(19) United States
(12) Patent Application Publication
(10) Pub. No.: US 2014/0373622 A1
(43) Pub. Date: Dec. 25, 2014

(54) WIRELESS FUEL SENSOR

(71) Applicant: Simmonds Precision Products, Inc., Vergennes, VT (US)

(72) Inventors: Bruce R. Kline, Starksboro, VT (US); Brandon R. Hicks, Ferrisburgh, VT (US)

(21) Appl. No.: 13/923,657

(22) Filed: Jun. 21, 2013

(51) Int. Cl. B64D 37/00; G01F 23/00

(52) U.S. Cl. CPC B64D 37/005; G01F 23/0007
USPC 73/290 R

(57) ABSTRACT

Embodiments of the disclosure include wireless fuel systems for an aircraft. The system include wireless fuel sensors having a sensor configured to measure an indication of an amount of fuel in a fuel tank, a transmitter coupled to the sensor, an antenna coupled to the transmitter and a generator configured to provide power to the sensor and the transmitter. The system also includes a controller configured to receive data from each of the plurality of wireless fuel sensors and to responsively calculate the amount of fuel in a fuel tank.

### BACKGROUND OF THE INVENTION

The present disclosure relates to fuel sensors for an aircraft, and more specifically, to wireless fuel sensors for aircrafts.

Currently, aircraft fuel gauges use capacitance probes mounted within the fuel tanks to monitor the amount of fuel in the tank. In general, these probes are disposed inside the fuel tank and extend from the bottom to the top of the tank. Accordingly, wires must be routed within the tank to excite and read the probes. For a variety of reasons, such as safety, maintenance, and construction reasons, it is desirable to eliminate the long probes and wiring within the fuel tanks.

Recently, pressure and ultrasonic sensors have been developed to eliminate the use of long conductive probes disposed inside of fuel tanks. Currently, optical fibers or external mounting can be used to eliminate the use of conductive wires in the tank. While the use of externally mounted sensors works well for some sensor locations, external placement of a fuel sensor on certain parts of a wing tank forces wires or optical cable to be routed in the airflow. In addition, the use of long conductive wires along the wings of the aircraft, adjacent to the fuel tank, poses various safety concerns.

### BRIEF DESCRIPTION OF THE INVENTION

According to one embodiment, a wireless fuel system for an aircraft having a plurality of wireless fuel sensors is provided. Each wireless fuel sensor includes a sensor configured to measure an indication of an amount of fuel in a fuel tank, a transmitter coupled to the sensor, an antenna coupled to the transmitter, and a battery configured to provide power to the sensor and the transmitter. The wireless fuel system also includes a controller configured to receive data from each of the plurality of wireless fuel sensors and to responsively calculate the amount of fuel in a fuel tank.

Accordingly to another embodiment, a wireless fuel system for an aircraft having a plurality of wireless fuel sensors is provided. Each wireless fuel sensor includes a sensor configured to measure an indication of an amount of fuel in a fuel tank, a transmitter coupled to the sensor, an antenna coupled to the transmitter, and a generator configured to provide power to the sensor and the transmitter. The wireless fuel system also includes a controller configured to receive data from each of the plurality of wireless fuel sensors and to responsively calculate the amount of fuel in a fuel tank.

Accordingly to a further embodiment, a wireless fuel system for an aircraft having a plurality of wireless fuel sensors is provided. Each wireless fuel sensor includes a sensor configured to measure an indication of an amount of fuel in a fuel tank, a transmitter coupled to the sensor, an antenna coupled to the transmitter, a battery configured to provide power to the sensor and the transmitter, and a generator configured to charge the battery. The wireless fuel system also includes a controller configured to receive data from each of the plurality of wireless fuel sensors and to responsively calculate the amount of fuel in a fuel tank.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a portion of an aircraft having a wireless fuel sensor system in accordance with an embodiment of the disclosure;

FIG. 2 is a block diagram of a wireless fuel sensor in accordance with an embodiment of the disclosure; and

FIG. 3 is a schematic diagram illustrating a wireless fuel sensor in accordance with an embodiment of the disclosure.

### DETAILED DESCRIPTION OF THE INVENTION

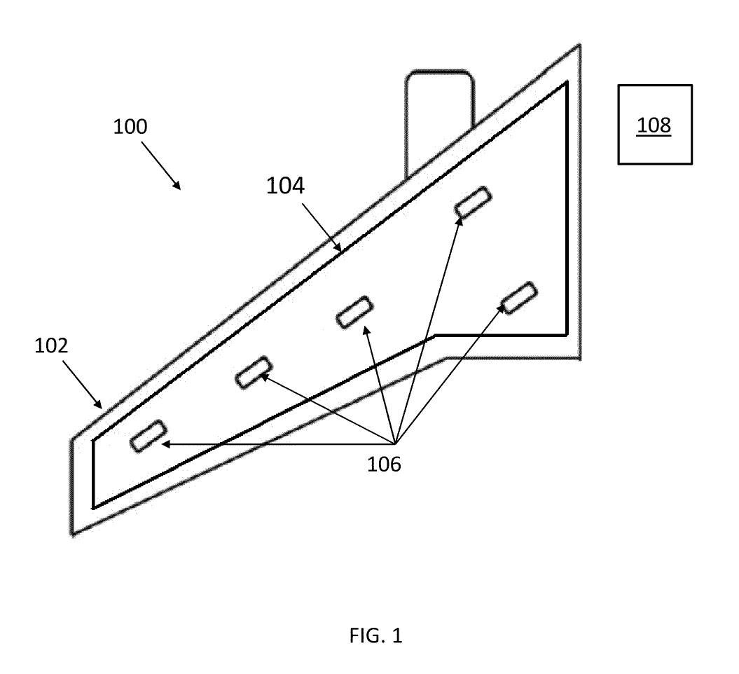

Referring now to FIG. 1, a schematic diagram of a portion of an aircraft having a wireless fuel sensor system 100 in accordance with an embodiment of the disclosure is shown. In one embodiment, the aircraft includes a fuel tank 104 disposed within a wing 102 of the aircraft. The wireless fuel sensor system 100 includes a plurality of wireless fuel sensors 106 that are disposed at various locations along a surface of the fuel tank 104. In an embodiment, each of the wireless fuel sensors 106 is configured to communicate with a controller 108, which is configured to calculate the amount of fuel in the tank 104 based on the information it receives from the wireless fuel sensors 106.

In one embodiment, the wireless fuel sensor system 100 includes several wireless fuel sensors 106 that are positioned to provide an accurate measurement of the amount of fuel in the fuel tank 104, over all flight attitudes, with the minimum number of sensors. The usage of each of the wireless fuel sensors 106 may depend on the location of the wireless fuel sensor 106 within the fuel tank 104. Each wireless fuel sensor 106 may be used as a primary sensor or as a secondary sensor used to increase the accuracy of the wireless fuel sensor system 100 when the fuel level is low. In various embodiments, the wireless fuel sensors 106 may be placed anywhere on the exterior of the fuel tank 104, or between tank baffles. In one embodiment, by removing the wires need by the fuel sensors, the wireless fuel sensors 106 are able to be located in all areas of the aircraft.

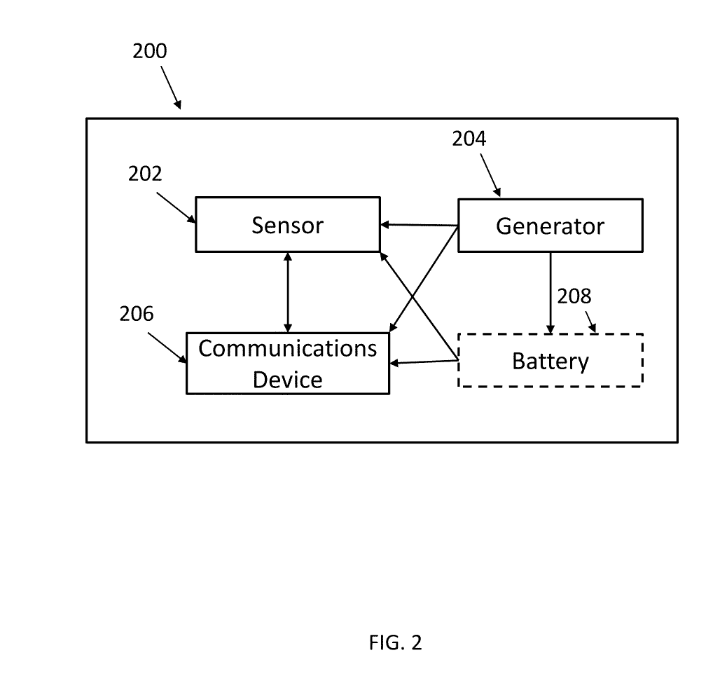

Referring now to FIG. 2, a block diagram of a wireless fuel sensor 200 in accordance with an embodiment of the disclosure is shown. As illustrated, the wireless fuel sensor 200 includes a sensor 202 and a communications device 206. In one embodiment, the wireless fuel sensor 200 may include a generator 204. In one embodiment, the wireless fuel sensor may also include a battery 208 configured to receive and store power from the generator 204, or merely to provide storage for energy without regeneration. In one embodiment, the sensor 202 may be a pressure sensor, an ultrasonic sensor, or any other suitable type of sensor that is capable of measuring an amount of fuel in a portion of the fuel tank. In one embodiment, the sensor 202 may be a pressure sensor that has a sampling rate of five or more samples per second. In another embodiment, the sensor 202 may be an ultrasonic sensor that has a similar sampling rate. In various embodiments, the sampling rates of the sensor 202 may be set to a rate high enough to average out the effects of the fuel sloshing in the tank.

In one embodiment, the generator 204 is configured to harvest energy from the operating environment of the aircraft. For example, the generator 204 may be configured to convert thermal, vibration, solar, or other types of energy into electrical power. The generator 204 may be configured to provide electrical power directly to the sensor 202 and the communications device 206 or may be configured to provide electrical power to the battery, which in turn powers the sensor 202 and the communications device 206.

In one embodiment, the communications device 206 includes a radio frequency (RF) transmitter and may also include a RF receiver. In one embodiment, the wireless fuel sensor 200 may be configured to only be a data source, and be configured without a receiver to minimize energy usage. In one embodiment, the communications device 206 is configure to use a low rate, low overhead communication protocol like IEEE 802.15.4. By using such a communications protocol, the amount of energy used by the communications device 206 is decreased and allows for the highest possible sample rate while minimizing energy used. In embodiments in which the communications device 206 includes both an RF transmitter and receiver, full bidirectional communication can be added to the wireless fuel sensor 200 to allow advanced functionality.

In one embodiment, the communications device 206 includes an antenna that may or may not protrude beyond the tank wall depending on the type of antenna used. In various embodiments, the antenna may include, but is not limited to, a patch antenna, a slot antenna, a traveling wave antenna, a folded and unfolded dipoles and monopoles. In one embodiment, the antenna is aerodynamically shaped and/or enclosed within an aerodynamic radome.

In one embodiment, the generator 204 is a thermoelectric generator that is thermally connected such that heat flows from the fuel in the tank, through a heat conductor, through the thermoelectric generator, and into the air. The direction of heat flow depends on the temperatures of the fuel and the air. In general, the outside air temperature drops below that of the fuel as aircraft ascends, the fuel cools while cruising at altitude, and the outside air temperature rises above the temperature of the fuel as aircraft descends.

In one embodiment, the wireless fuel sensor 200 may be designed to operate only when power is being supplied from the generator 204. For example, in embodiments without a battery 208, the wireless fuel sensor 200 only operates when the generator 206 is providing power. In such embodiments, the wireless fuel sensor 200 is configured to augment other sensors to improve general accuracy, improve accuracy over attitude, reduce errors due to baffles and other tank features, and enhance reliability and availability through redundancy. In another embodiment, the wireless fuel sensor 200 may be designed to use energy that has been previously generated and stored in the battery 208. In embodiments that include a battery 208, the previously stored energy will be available during flight when the sensors are needed, even if the generator 204 is not currently supplying power, for example during the cruise phase of the flight.

In one embodiment, the wireless fuel sensor 200 may be mounted on the outside the fuel tank, allowing access to thermal gradients, thermal changes, or vibration energy to harvest and to allow antennae to be mounted external to the fuel tank. In other embodiments, the wireless fuel sensor 200 may be mounted on the inside of the fuel tank and the tank wall may include an RF window allowing communication.

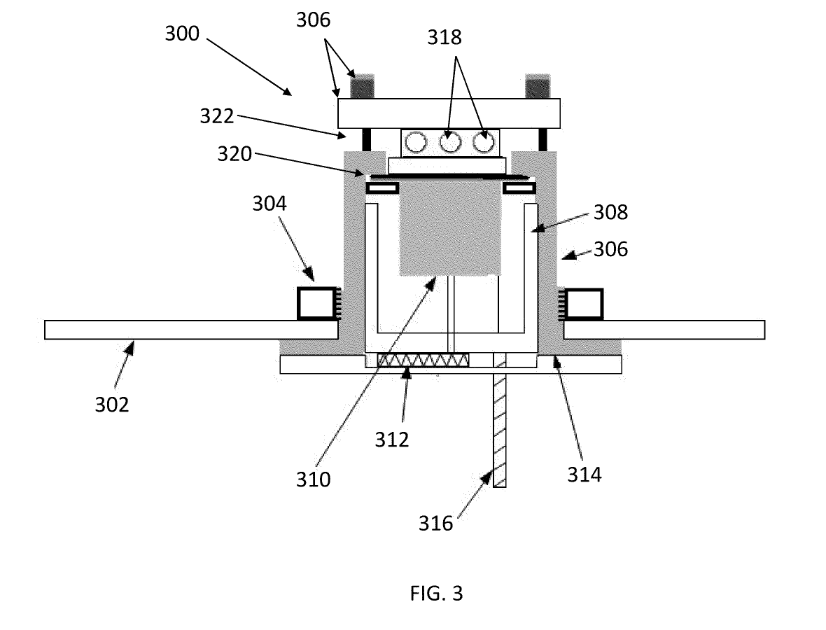

Referring now to FIG. 3, a block diagram of a wireless fuel sensor 300 in accordance with an embodiment of the disclosure is shown. As illustrated, the wireless fuel sensor 300 is affixed to a fuel tank wall 302 by multiple flange nuts 304. In one embodiment, the tank wall 302 is the bottom skin of a wing tank. The flange nuts 304 and the flange 314 are configured to ensure that the fuel tank is properly sealed. The wireless fuel sensor 300 includes a housing 306, which may include several pieces or have a uni-body construction. The housing 306 is configured to engage the flange nuts 304 that are disposed in the fuel tank and to have an opening 322 configured to allow the fuel in the tank to reach one or more apertures 318. The wireless fuel sensor 300 also includes a sensor module 310 that includes sensors, such as pressure transducers, configured to measure the amount of fuel in the tank. In one embodiment, the sensors of the sensor module 310 are disposed in the apertures 318. In one embodiment, the sensor module 310 also includes other electronics such as a receiver and transmitter.

Continuing with reference to FIG. 3, the wireless fuel sensor 300 includes a thermoelectric generator 312 which is disposed next to a conductor 308. The thermoelectric generator 312 is configured to generate electric power and to provide it to the sensor module 310. In one embodiment, the wireless fuel sensor 300 includes an antenna 316 which is in communication with the sensor module 310. During operation, the sensor module 310 receives power from the thermoelectric generator 312 and measures the amount of the fuel in the tank using its one or more sensors. The sensor module 310 periodically transmits the measurement data via the antenna 316.

In one embodiment, the wireless fuel sensor includes an energy storage device and is configured to use a wake on RF system. The wake on RF system allows the wireless fuel sensor to sleep and save the stored energy when not needed and to wake and operate from the stored energy at any time regardless to the availability of energy from the generator. In one embodiment, the wake of RF system can be added to the wireless fuel sensor to control when a sample is taken and transmitted. The wake on RF system can be enhanced to request specific data such as fuel pressure, echo time, temperature, and sensor health.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A wireless fuel system for an aircraft comprising:
a plurality of wireless fuel sensors each comprising:
a sensor configured to measure an indication of an amount of fuel in a fuel tank;
a transmitter coupled to the sensor;
an antenna coupled to the transmitter; and
a battery configured to provide power to the sensor and the transmitter; and
a controller configured to receive data from each of the plurality of wireless fuel sensors and to responsively calculate the amount of fuel in a fuel tank.

2. The wireless fuel system of claim 1, wherein each of the plurality of wireless fuel sensors are at least partially disposed within the fuel tank.

3. The wireless fuel system of claim 1, wherein each of the plurality of wireless fuel sensors are configured to periodically transmit the indication of the amount of fuel in a fuel tank to the controller.

4. The wireless fuel system of claim 1, wherein each of the plurality of wireless fuel sensors further comprises a receiver configured to receive commands from the controller.

5. The wireless fuel system of claim 1, wherein each of the plurality of wireless fuel sensors further comprises a low powered receiver configured to receive a wake signal from the controller.

6. The wireless fuel system of claim 5, wherein each of the plurality of wireless fuel sensors are configured to transmit the indication of the amount of fuel in a fuel tank to the controller in response to receiving the wake signal from the controller.

7. A wireless fuel system for an aircraft comprising:
a plurality of wireless fuel sensors each comprising:
a sensor configured to measure an indication of an amount of fuel in a fuel tank;
a transmitter coupled to the sensor;
an antenna coupled to the transmitter; and
a generator configured to provide power to the sensor and the transmitter; and
a controller configured to receive data from each of the plurality of wireless fuel sensors and to responsively calculate the amount of fuel in a fuel tank.

8. The wireless fuel system of claim 7, wherein the generator is a thermoelectric generator.

9. The wireless fuel system of claim 7, wherein the generator is a photoelectric generator.

10. The wireless fuel system of claim 7, wherein the generator is a vibration energy harvester.

11. The wireless fuel system of claim 7, wherein each of the plurality of wireless fuel sensors are at least partially disposed within the fuel tank.

12. The wireless fuel system of claim 7, wherein each of the plurality of wireless fuel sensors are configured to periodically transmit the indication of the amount of fuel in a fuel tank to the controller.

13. The wireless fuel system of claim 7, wherein each of the plurality of wireless fuel sensors further comprises a receiver configured to receive commands from the controller.

14. The wireless fuel system of claim 7, wherein each of the plurality of wireless fuel sensors further comprises a low powered receiver configured to receive a wake signal from the controller.

15. The wireless fuel system of claim 14, wherein each of the plurality of wireless fuel sensors are configured to transmit the indication of the amount of fuel in a fuel tank to the controller in response to receiving the wake signal from the controller.

16. A wireless fuel system for an aircraft comprising:
a plurality of wireless fuel sensors each comprising:
a sensor configured to measure an indication of an amount of fuel in a fuel tank;
a transmitter coupled to the sensor;
an antenna coupled to the transmitter;
a battery configured to provide power to the sensor and the transmitter; and
a generator configured to charge the battery; and
a controller configured to receive data from each of the plurality of wireless fuel sensors and to responsively calculate the amount of fuel in a fuel tank.

17. The wireless fuel system of claim 16, wherein the generator is a thermoelectric generator.

18. The wireless fuel system of claim 16, wherein the generator is a photoelectric generator.

19. The wireless fuel system of claim 16, wherein the generator is a vibration energy harvester.

20. The wireless fuel system of claim 16, wherein each of the plurality of wireless fuel sensors are at least partially disposed within the fuel tank.
